(19) United States
(12) Patent Application Publication
(10) Pub. No.: US 2003/0110061 A1
(43) Pub. Date: Jun. 12, 2003

(54) Simplified variable life insurance

(76) Inventors: Cary Lakenbach, West Hartford, CT (US); Michael LeBoeuf, Simsbury, CT (US)

Correspondence Address: ST. ONGE STEWARD JOHNSTON & REENS, LLC, 986 BEDFORD STREET, STAMFORD, CT, 06905-5619, US

(21) Appl. No.: 10/218,543

(22) Filed: Aug. 14, 2002

Related U.S. Application Data
(60) Provisional application No. 60/313,742, filed on Aug. 21, 2001.

(51) Int. Cl. G06F 17/60

(52) U.S. Cl. 705/4

(57) ABSTRACT

The present invention provides a tax-advantaged investment product, particularly, a simplified flexible premium life insurance product, in which the traditional cost of insurance charge is not a separate charge. Instead an asset charge, which is calculated as a percentage of the accrued value of the insurance policy, is deducted from any premiums paid and/or from cash dividends accrued in the policy. The invention provides an easily understood method for the policyholder to understand and predict the future cost of the policy.

This application is based on, and we claim priority rights under 35 U.S.C. §119(e) from, U.S. Provisional patent application serial No. 60/313,742, filed Aug. 21, 2001.

### FIELD OF THE INVENTION

The present invention relates to the field of financial products and methods used in connection with retirement and estate planning. In particular, it relates to life insurance products.

### BACKGROUND OF THE INVENTION

There are numerous types of financial products available in the marketplace. Some products are relatively simple, and some are quite complex. The present invention relates to methods to obtain some of the substantial tax benefits available to life insurance financial products while making the products simpler for the consumer policyholder to understand, and to make it simpler to plan for the necessary premium payments. This background provides a review of the structure of and tax effects of some typical financial products.

Savings Accounts: A savings account is a simple financial instrument. Deposits are made, withdrawals are made, and interest is credited periodically, based on a specified interest rate for the relevant time periods. In a savings account there is no risk of loss of capital. The institution offering the savings account guarantees that both principal and interest (less fees) will be paid, and if the institution becomes insolvent, there is a federal deposit insurance program to cover the losses. In some banks, a fee may be levied against the account, such as when the balance falls below certain thresholds. A savings account has an explicit investment return in the form of interest, and both its return and cost structure are understood by consumers. The interest earned in a savings account in general is taxable as ordinary income (unless held in an IRA ,for example).

Mutual Funds: A mutual fund is an investment company in which the consumer purchases shares. The investment company then makes investments for the benefit of the investors. Many typical mutual funds are set up so that to the consumer, they operate in a way very similar to the operation of a savings account, but with some important differences regarding the fees involved, and the risk to invested funds. A mutual fund will typically have a management fee associated with it, which is charged by the fund manager to all investors in the fund. The management fee that the fund manager charges is typically a percentage of the assets under management. Some mutual funds may also have front-end loads or back-end loads (essentially, a percentage sales fee), in addition to the investment management fee. Another difference from a savings account is that the gross yield is not known in advance. There is a risk of loss of capital in the event of a substantial loss in the operation of the fund. Most consumers understand the return, the risk, and the cost structure involved in a mutual fund.

The tax treatment of mutual funds is based on the type of return delivered by the investment. A mutual fund may provide dividends which are treated as ordinary income, or as capital gains, depending on the nature of the security and transaction that generates the dividend. In addition, the sale of mutual fund shares is treated as a capital gain. In most cases, an investor who switches between different mutual fund investments will trigger the tax consequences of a sale of mutual fund shares.

Life Insurance And Annuity Products: Life insurance products and annuity products are considered tax advantaged because they allow deferral of income taxes on investment growth until the time that the earnings from the investment are withdrawn. Life insurance and annuity tax treatment differs significantly from that of mutual funds in that all gains and investment income earned are sheltered from tax until the funds are withdrawn from the investment. This ability to defer income tax is a major tax advantage of life insurance and annuities over mutual funds. Also, in life insurance and annuity products, the contract holder can move monies between investment options without incurring a tax consequence. However, it should be noted that upon withdrawal of the funds from an annuity contract, the contract holder's gain is taxed as ordinary income, in contrast to the treatment of mutual fund gains, where the gain is taxed using capital gains tax treatment.

Annuities: An annuity contract is a contract that pays the annuity beneficiary a fixed amount at regular intervals during the life of one or more individuals (annuitants). Two main types of annuities are deferred annuities and immediate annuities.

Deferred annuity contracts are used to allow funds to be accumulated on a tax deferred basis over the term of the contract; in a deferred annuity, the payout of periodic payments to the annuity recipient begins at a certain time in the future, such as reaching age 65. The decision whether to convert the deferred annuity into a payment stream is the buyer's. The decision to do so is known as annuitization. Thus for example, a person may fund a deferred annuity and, upon retirement of that person, the insurer holding the annuity pays the retiree a series of periodic payments. Such products are desirable because the earnings are retained and grow on a tax-deferred basis; income tax is incurred when the annuity payments are received, often when the retiree is in a lower tax bracket.

The bulk of annuities that are sold are deferred annuities, suggesting that consumers focus on the accumulation of dollars on a tax favored basis as an important aspect of this investment vehicle. The accumulated value of the deferred annuity contract is recovered by the consumer by annuitization or by withdrawals. These two approaches have different tax effects. In annuitization, the annuitant's capital is returned as a percentage of each annuity payment received, and is a non-taxable return of capital; the remainder of the annuity payment is taxable as ordinary income. In withdrawals, the payments to the consumer are treated on a LIFO basis, so the withdrawals immediately create income tax on the withdrawn amounts (to the extent of gain) as ordinary income.

An immediate annuity is funded with a one-time investment, and distributions typically begin within a month. Immediate annuity contracts are often life annuities, under which the annuity beneficiary is paid from the start date of the contract until death.

There are two main investment options available in annuity products, namely fixed annuities or variable annuities. A fixed annuity pays the annuity recipient a guaranteed sum of money at periodic intervals. Where the product is a fixed annuity, typically the life insurance company will usually invest conservatively with an emphasis on fixed income assets such as high grade corporate bonds. A variable annuity pays a variable return that is either keyed to an index such as the S & P 500® index or varies according to the performance of the separate account categories in which the annuitant has invested his assets.

The annuity payout period can be selected from a number of options, ranging from a life annuity, with payments made for the life of the annuity owner; or the life of the annuity owner and a second person (such as the annuity owner's spouse); or income for a specific period of time, such as 15 years. Income tax is paid (on earnings as opposed to principal) only as the annuitant receives his payments. Annuity payments will be taxed based on the investment in contract formula. In an annuity product, the annuity issuer bears the risk that the annuitant will live longer than predicted. The annuitant bears the risk of dying sooner than expected

Annuity contracts are administered with a number of associated typical fees. The surrender charge is a fee charged in the event of early withdrawal of the annuity investment. The surrender charge is a back-end charge that typically declines over a number of years and is inapplicable after 8-10 years. The charge compensates the company for the commission outlay that is not recompensed through excess interest earnings in the event of early withdrawal or termination of the contract.

The mortality and expense risk charge (referred to as an M & E charge) is an annual charge equal to a certain percentage of the value of the annuity account, typically in the range of 1.25 percent per year. This charge is typically applied to compensate the insurance company for insurance risks it assumes under the annuity contract. Thus for example, if an annuity has an average account value of $20,000, at a 1.25% mortality and expense risk charge there will be a $250 annual charge.

The tax treatment of annuities differs significantly from that of mutual funds. In an annuity product, all gains and investment income earned within the funds are sheltered from tax until the contract holder surrenders or makes a withdrawal from his contract. This ability to defer income is a major tax advantage of annuities over mutual funds.

Upon surrender of the contract, whether full or partial, the contract holder's gain is taxed as ordinary income, in contrast to the treatment of the mutual fund, where the sale of mutual fund shares is taxed using capital gains tax treatment. This tax aspect of an annuity is generally less desirable than the mutual fund treatment. If a contract holder wishes to partially surrender the annuity, e.g., extract some amount of cash from his holdings, these amounts will be taxed on a last in first out (LIFO) basis. As an example, if the contract holder had paid in $100,000, now has a contract value of $300,000, and wishes to extract $50,000 in cash, he will be fully taxed on the $50,000, because the gain in the contract is $200,000 and is considered to be withdrawn first under the LIFO rules.

Life Insurance: Life insurance products, such as whole life and universal life insurance products are financial products that include a death benefit component (a component similar to buying term insurance) as well as a cash value accumulation component. Life insurance products have fairly complex legal structures that underpin the familiar product known to consumers.

The pricing of any life insurance product (including term and whole and universal life policies) is dependent on complex actuarial formulas that determine insurance pricing based upon the expected mortality experience of the policyholder. This cost determination is known as the cost of insurance (COI) calculation.

A discussion of the COI charge with a specific example will aid understanding of this charge. In this example, it is assumed that the premiums are applied to the life insurance policyholder's account and that there are no deductions for commissions or other charges. Suppose the accrued value of a whole life insurance account is $250,000 and that the death benefit is $1,000,000. A premium payment of $50,000 is made so that the account value increases to $300,000. If the policyholder were to die at this point, the insurer would be at risk for the amount of $700,000, since that is the amount in addition to the accrued account value that is needed to pay a death benefit of $1,000,000. Consequently, the COI charge is the product of a rate that reflects the risk of the insured's death and the $700,000 amount at risk.

Thus, for any given insured, the greater the amount of premiums paid to date, the higher the account value will be, and therefore the lower the amount at risk. As the amount at risk declines over time, the amount charged by the insurance company for the COI charges will also decline. This declining COI charge increases the amount of the premium that can be applied to increasing the account value. Thus, the account value of a typical life insurance policy will increase more rapidly in the later years of the policy.

In a modern insurance contract known as a flexible premium variable universal life contract, the policyholder has a virtually unlimited ability to pay premiums when he wants to and at the level he wants to. (See the next section regarding the Definition of Life Insurance.) Of course, the amount paid has to result in an account value that is large enough to cover the COI charges to pay for the death benefit. As discussed above, the COI charge is a variable charge based on the net amount at risk. It is not a constant portion of every premium payment. Thus, an unsophisticated or undisciplined policyholder who has a flexible premium life insurance policy (i.e. a policy that does not require a fixed premium payment) may have little understanding of the COI charge he is responsible for, and the policy may never build up a substantial cash value if the amount of premiums paid are so small that all the premiums paid are applied to the COI charge.

Life insurance policies are given particularly beneficial income tax treatment. The death benefit is paid to the insured's beneficiary free of income tax. In addition, like an annuity, the earnings of the policy that increase the account value accumulate on a tax-deferred basis. To be considered life insurance that is eligible for this tax treatment, the policy must satisfy the requirements of Section 7702 of the Internal Revenue Code, a section that defines the so-called Definition of Life Insurance. The insurance policy must satisfy at least one of two available tests. Under one test, the so-called Cash Value Accumulation Test (CVAT), the policy must maintain a specified minimum death benefit to account value relationships. These death benefit to account value relationships decrease with increasing age. The other test, the Guideline Premium Test, limits the amount of premium that may be paid into the contract as well as requires minimum net amounts at risk.

Life Insurance contracts are broken down to two categories: (1) Non-Modified Endowment Contracts (commonly called a “non-MEC”); and (2) Modified Endowment Contracts (commonly called a “MEC”).

A non-MEC policy is given a more desirable tax treatment than a MEC policy. The difference in the tax treatment is that distributions made from a non-MEC policy during the lifetime of the insured are taxed on a FIFO (first-in-first-out) basis. This means that the first part of any distributions can be withdrawn tax-free because the policyholder's contributions into the policy are drawn out first. This return of capital is a non-taxable event. Only after these contributions are withdrawn is income tax triggered, upon the withdrawal of investment earnings which have accrued under the policy.

Distributions made from the MEC policy during the lifetime of the insured are less desirable because distributions from a MEC policy are taxed on the LIFO basis. This means that any withdrawal will immediately trigger income tax on the amounts withdrawn from the policy. Under a MEC, loans are treated as distributions whereas when the policy is a non-MEC the loan is not a taxable event.

The difference in taxes between a non-MEC policy and a MEC policy can be seen from the following two examples.

### EXAMPLE 1

### MEC Policy

A life insurance policy has a basis of $100,000 (amounts paid in by the policyholder), and a gross cash value (basis plus accrued earnings) of $500,000. The policyholder wishes to withdraw $100,000. The withdrawn $100,000 comes out of the policy's gain (investment earnings) of $400,000. It is fully taxed as regular income. The remaining cash value is $400,000. Any additional sums withdrawn will also be taxed, except for the last $100,000 (the policyholder's basis).

### EXAMPLE 2

### Non-MEC Policy

A life insurance policy has a basis of $100,000, and a gross cash value of $500,000. The policyholder wishes to withdraw $100,000. The withdrawn $100,000 reduces the policy's basis of $100,000 to zero. The withdrawal is a return of the policyholder's own money and is not taxed. The remaining cash value is $400,000. If the policyholder withdraws any additional sums, the withdrawal is taxable as ordinary income since the basis is zero.

However, in a non-MEC there is a way to access these additional sums without incurring a tax. In a non-MEC, a loan against the cash value is not considered a distribution and is therefore not subject to tax. Consequently, if in the above example, if instead of making a withdrawal, a $200,000 loan were taken against the cash value, the gross cash value would remain at $500,000, a loan account of $200,000 would be set up, and the net cash value would be $300,000. But, no tax would be due on the withdrawal. Thus, a policyholder who accumulates a cash value in a non-MEC can legally and legitimately avoid income taxes using policy loans. It should be noted that if the policyholder later surrenders the contract, he will incur full taxes on his gain.

The critical definition used in distinguishing a non-MEC policy from a MEC policy is contained in Section 7702A of the Internal Revenue Code. To qualify as a non-MEC, the policy must meet a principal requirement, called the “7-Pay test”. The 7 Pay test compares the premiums paid under the contract in the first seven policy years with the premiums that would be paid under a seven-pay premium contract. A seven-pay contract is a contract that would require no more premiums after the payment of seven equal annual premiums. Thus, typically a policy will be considered a MEC if the policy premiums are paid more rapidly than would be paid under the seven-pay contract; in other words, if the dollar value of the annual premiums paid in a life insurance contract exceeds the premiums that would be needed under the seven-pay contract, then the insurance policy will be regarded by law as a MEC policy. If the annual premiums paid have a dollar value which is equal to or less than the amount of premiums needed under the seven pay contract, then the policy should be regarded by the IRS as a non-MEC policy.

The taxation of distributions in a non-MEC life insurance policy is considerably more favorable than the taxation of annuities. However, the legal issues are relatively complex, and the average consumer has difficulty comprehending the issues. These complexities also make it difficult for salespersons who are not highly trained in the insurance and tax law issues to appropriately market the product to consumers. A non-MEC life insurance policy is far more complicated than a simple savings account. This complexity can be a deterrent to salespersons, who may be motivated to suggest a relatively simpler annuity product instead of the life insurance product. Also, it is often difficult for a consumer to correctly understand the overall policy costs associated with such products.

It would be desirable to have a variable life insurance policy having the tax advantages of a non-MEC policy, but which is simpler to understand, and more easily explained and sold by a salesperson.

### SUMMARY OF THE INVENTION

It is an object of the invention to provide a tax-advantaged insurance vehicle that has a simple policy charge structure.

It is an object of the invention to provide such a tax-advantaged insurance vehicle designed to have asset charges as the only required source of revenue to cover the mortality cost, and if desired, other costs of the insurance product, such as administration cost and sales costs.

It is an object of the invention to provide such a tax-advantaged insurance product designed to have asset charges determined as a percentage of the cash value of the insurance product.

In accordance with one embodiment of the invention, a method of administering life insurance product in which an asset charge, such as a percentage of the account value, are used to cover those expenses typically covered by the COI charge. In one preferred embodiment, the asset charge may also be used to cover other costs of the insurance product, such as administration costs and sales costs.

The benefit of the invention is that it provides an easily understood method for the policyholder to understand and predict the future cost of the policy. In addition, as implemented above, the invention provides the tax advantages of life insurance, including the ability to accumulate dollars on a tax-deferred basis, then access those dollars on a tax-free basis during retirement, and legitimately receive an income tax free death benefit.

Other objects, aspects and features of the invention in addition to those mentioned above will be pointed out in or will be understood from the following detailed description in conjunction with the drawings.

### BRIEF DESCRIPTION OF THE DRAWINGS

FIG. 1 is a flowchart showing the steps of one embodiment of a method in accordance with the invention.

FIG. 2 is a flowchart showing implementation of the invention in one software embodiment.

### DETAILED DESCRIPTION OF THE DRAWINGS

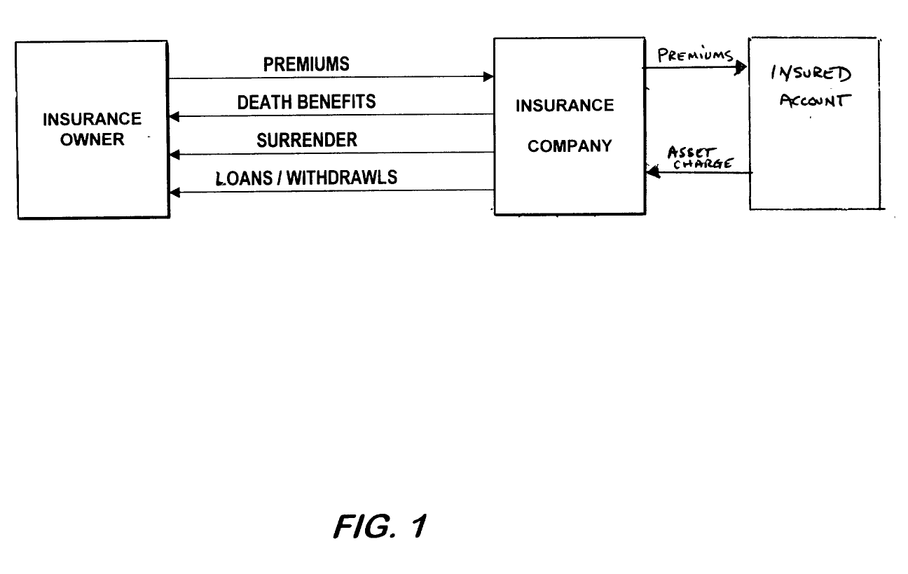

The present invention comprises a life insurance product that uses asset charges to cover the COI charge, and/or management and other expenses and fees typically associated with a life insurance product. In particular, the invention is a flexible premium life insurance policy that uses such asset charges. Referring now to FIG. 1, the asset charge is calculated by applying a percentage (also referred to as the basis point amount) to the account value. Thus for example, an asset charge in the range of 0.5 to 5.0 percent (50 to 500 basis points) of the then existing account value could be applied at periodic intervals. It is intended that the asset charge equal or exceed the COI charge found in conventional insurance products. In order to select an asset charge that correlates to the COI charge there are several factors to be considered.

The first factor is the underwriting factor, which takes account of the age, sex, and underwriting class of the insured at the time of issue of the product. (“Underwriting class” refers to classifications made by underwriters in evaluating the mortality risk of the insured, for example, smoker/non-smoker). In general, the administration of the product is simplified if a single asset charge rate for the policy can be selected at the time of issue of the product, and applied for the term of the policy or for some specific portion of the policy term. This then requires a separate calculation of the asset charge for each age/sex/underwriting class (or age/sex underwriting class bracket) at the time of product issue, and at subsequent stages of the policy term. In one embodiment, there is a fixed asset charge rate for the term of the policy. In an alternative preferred embodiment, there is an initial asset charge rate for policy years 1-10, then a second asset charge rate for years 11 and all subsequent years. In an alternative embodiment, the second asset charge rate applied for years 11-20, and a third asset charge rate is applied in year 21 and all subsequent years. In yet another alternative embodiment, the asset charge rate may change after every 5 years. Other periods may be selected and applied based on acceptance in the marketplace and expected difficulty in prediction of the COI charge.

The use of a universal uniform asset charge rate for all ages/sexes/underwriting classes based on an average rate is undesirable, because then the charge for older insureds will be less than the actual COI charge, and the charge for younger insureds will be greater than the actual COI charge. However, there are age/sex/underwriting class brackets that can be used that provide an acceptably small range of actual COI charge so that a single asset charge rate can be applied to this age bracket. (For example, issue ages 40-44, ages 45-49, ages 50-54, may well be appropriate age brackets for use in the invention.)

In cases where the asset charge rate will change after a certain period, the asset charge rate may be fixed at the time of the life insurance policy is issued, or it may be left unspecified. In general, for regulatory reasons and commercial acceptance reasons, an unspecified asset charge rate may not be commercially acceptable, but if at the same time the insurance company is unable to predict a correct asset charge rate, the insurance company may instead specify a future asset charge rate as a range, for example the range will be 250-350 basis points.

The second factor in the determination of the asset charge rate is the rate, and level, at which premiums are paid. If premium payments are relatively low, then the account value will be relatively low, and consequently the asset rate would need to be set quite high. If this occurs, the insurance product will not be very attractive, as it then essentially becomes a vehicle for the death benefit only, and will not have the intended beneficial effect as an investment oriented insurance vehicle. The present invention performs most attractively principally when the premium payments are relatively high, and the account value is built up as rapidly as possible, so that the asset charge can be set at a relatively low rate.

The asset charge rate may be selected based on the account value. This can allow a close correlation between the asset charge and an equivalent COI charge.

In alternative embodiments of the invention, there may be different asset charge rates applied against different tiers of the account value. For example, one asset charge rate may be applicable to account value of $1,000,000 or less, and a different rate may be applied to greater account values. Or the asset charge rate may be applied only to account value up to a threshold value.

An issue to be considered in setting the asset charge is the range of other fees or costs to be covered by the asset charge. In typical life insurance policies there are charges such as an administrative expense charge, a contingency charge (also known as the M&E Charge), and surrender charges. These types of charges can all be determined and included in the specified asset charge rate

A further issue to the determination of the asset charge is the structure of the insurance contract, to provide the insurance company with the assurance that the premium payments will be made at the level that allows the asset charge structure to be provided. In such case, the life insurance contract should include terms that require a minimum cumulative premium payment. Optimally, to provide the lowest asset charge rate, the required premium payments would be set at the level of a seven-pay contract. (Premium payments having a value which is higher are undesirable because then the policy will be treated as a MEC policy, with its less favorable tax treatment). In general, the invention is most effective where is structured with a high required initial premium range that is as close as possible to the seven pay contract, for example, requiring a cumulative premium level to be 85% of the levels of the seven pay contract. In a preferred embodiment, the insurance product is offered as a flexible premium contract, in which the policyholder can decide how much premium to pay into the contract after having paid a mandatory minimum amount of initial premiums.

At some premium levels, the mandatory minimum may be sufficient to maintain the policy by deduction of the asset charge from the value of the policy. In other cases, this may be insufficient to fund the policy, and the policyholder's charge structure may need to be converted to a conventional COI charge structure. There are alternative approaches that may be used to protect the policyholder if the contractually mandated premium levels aren't paid. These include termination of the contract or reduction in death benefits to levels that can be supported by the asset charge.

There may be occasions where a policyholder desires to pay the premium in a single lump sum payment, as for example, where a policyholder is receiving a payout from a 401 (k) account or an I.R.A. account, or has another investment that he desires to liquidate and/or transfer funds from. However, if such payment is applied to the life insurance contract in a single payment, the policy would be treated as a MEC policy. To avoid the unfavorable tax consequences of a MEC policy, the insurance company may set up appropriate investment vehicles to receive the lump sum payment, and to apply the payments to the life insurance policy over a seven-year period (or other appropriate period). The investment vehicles might include taxable mutual funds, and/or an annuity certain or a tax-free municipal bond fund. This “holding tank” investment vehicle would be selected to provide a stable rate of return and a low risk of loss of capital, to provide the consumer with assurance of funding the life insurance policy. In one preferred embodiment, the “holding tank” investment vehicle is an immediate annuity (either a fixed or variable annuity). The immediate annuity will be structured as a seven year immediate annuity and the annuity payments will be paid and/or applied to the cost of the life insurance contract.

A series of examples that demonstrate the invention are set forth below. In Examples 3-5, insureds of different ages and sex are given. In each case, the same premium payment is selected. As a consequence of selecting a standard premium payment, the amount of the death benefit for each insured will vary. The premium is the seven pay premium, the highest premium payment allowed without the policy becoming a MEC policy under the rules defined by I.R.C. Section 7702A. In the example, it can be seen that the amount of the death benefit increases over time. This increase is provided for in order to meet the definition of a life insurance contract in accordance with the cash value accumulation test of I.R.C. Section 7702. The credited rate is an assumed rate of return, and the 9.5% shown is comparable to illustrative rates commonly used in the industry. Of course, in a variable life insurance product, the rate of return is by definition variable. Although the credited rate of return is shown at 9.5%, the actual net rate of return will be less, as effectively the rate of return is reduced by the amount of the asset charge rate. As an example, for a male policyholder at an issue age below 65, 3.00% of the asset would be deducted as an Asset Charge in each of the first 10 policy years. In such case, if the credited rate is 9.5%, then the net rate of return is 6.5%. Again, however, it is emphasized that the 9.5% credited rate is intended as an illustrative rate only. In a commercial insurance policy, neither the earnings performance nor the level of the asset charge are likely to be guaranteed, though there may be certain minimums or maximums specified.

### EXAMPLE 3

Male, Aged 55 Nonsmoker

| Attained | | Credited | | Account | Cash | Death |
|---|---|---|---|---|---|---|
| Age | Duration | Rate | Premium | Value | Value | Benefit |
| 55 | 1 | 9.50% | 16,020.16 | 17,026.84 | 15,324 | 220,811 |
| 56 | 2 | 9.50% | 16,020.16 | 35,123.63 | 31,963 | 220,811 |
| 57 | 3 | 9.50% | 16,020.16 | 54,357.59 | 50,009 | 220,811 |
| 58 | 4 | 9.50% | 16,020.16 | 74,800.20 | 69,564 | 220,811 |
| 59 | 5 | 9.50% | 16,020.16 | 96,527.39 | 90,736 | 220,811 |
| 60 | 6 | 9.50% | 16,020.16 | 119,619.89 | 113,639 | 227,929 |
| 61 | 7 | 9.50% | 16,020.16 | 144,163.50 | 138,397 | 267,227 |
| 62 | 8 | 9.50% | 0 | 153,222.56 | 148,626 | 276,432 |
| 63 | 9 | 9.50% | 0 | 162,850.87 | 159,594 | 286,105 |
| 64 | 10 | 9.50% | 0 | 173,084.21 | 171,353 | 296,292 |
| 65 | 11 | 9.50% | 0 | 184,418.70 | 184,419 | 307,800 |
| 66 | 12 | 9.50% | 0 | 196,495.44 | 196,495 | 319,963 |
| 67 | 13 | 9.50% | 0 | 209,363.02 | 209,363 | 332,816 |
| 68 | 14 | 9.50% | 0 | 223,073.24 | 223,073 | 346,393 |
| 69 | 15 | 9.50% | 0 | 237,681.28 | 237,681 | 360,731 |
| 70 | 16 | 9.50% | 0 | 253,245.94 | 253,246 | 375,878 |
| 71 | 17 | 9.50% | 0 | 269,829.85 | 269,830 | 391,895 |
| 72 | 18 | 9.50% | 0 | 287,499.77 | 287,500 | 408,989 |
| 73 | 19 | 9.50% | 0 | 306,326.80 | 306,327 | 427,032 |
| 74 | 20 | 9.50% | 0 | 326,386.74 | 326,387 | 446,256 |
| 75 | 21 | 9.50% | 0 | 347,760.31 | 347,760 | 466,767 |
| 76 | 22 | 9.50% | 0 | 370,533.53 | 370,534 | 488,656 |
| 77 | 23 | 9.50% | 0 | 394,798.07 | 394,798 | 511,986 |
| 78 | 24 | 9.50% | 0 | 420,651.58 | 420,652 | 536,827 |
| 79 | 25 | 9.50% | 0 | 448,198.12 | 448,198 | 563,228 |
| 80 | 26 | 9.50% | 0 | 477,548.55 | 477,549 | 591,258 |
| 81 | 27 | 9.50% | 0 | 508,821.01 | 508,821 | 621,031 |
| 82 | 28 | 9.50% | 0 | 542,141.36 | 542,141 | 652,695 |
| 83 | 29 | 9.50% | 0 | 577,643.71 | 577,644 | 686,431 |
| 84 | 30 | 9.50% | 0 | 615,470.94 | 615,471 | 722,477 |
| 85 | 31 | 9.50% | 0 | 655,775.30 | 655,775 | 761,027 |
| 86 | 32 | 9.50% | 0 | 698,719.01 | 698,719 | 802,262 |
| 87 | 33 | 9.50% | 0 | 744,474.90 | 744,475 | 846,304 |
| 88 | 34 | 9.50% | 0 | 793,227.14 | 793,227 | 893,285 |
| 89 | 35 | 9.50% | 0 | 845,171.94 | 845,172 | 943,246 |
| 90 | 36 | 9.50% | 0 | 900,518.37 | 900,518 | 996,225 |
| 91 | 37 | 9.50% | 0 | 959,489.18 | 959,489 | 1,052,214 |
| 92 | 38 | 9.50% | 0 | 1,022,321.71 | 1,022,322 | 1,111,141 |
| 93 | 39 | 9.50% | 0 | 1,089,268.86 | 1,089,269 | 1,172,827 |
| 94 | 40 | 9.50% | 0 | 1,160,600.07 | 1,160,600 | 1,236,956 |
| 95 | 41 | 9.50% | 0 | 1,236,602.44 | 1,236,602 | 1,303,268 |
| 96 | 42 | 9.50% | 0 | 1,317,581.85 | 1,317,582 | 1,371,616 |
| 97 | 43 | 9.50% | 0 | 1,403,864.22 | 1,403,864 | 1,442,176 |
| 98 | 44 | 9.50% | 0 | 1,495,796.84 | 1,495,797 | 1,515,736 |
| 99 | 45 | 9.50% | 0 | 1,593,749.70 | 1,593,750 | 1,593,750 |

### EXAMPLE 4

Male, Aged 75 Nonsmoker

| Attained | | Credited | | Account | Cash | Death |
|---|---|---|---|---|---|---|
| Age | Duration | Rate | Premium | Value | Value | Benefit |
| 75 | 1 | 9.50% | 16,020.16 | 16,967.64 | 15,271 | 115,127 |
| 76 | 2 | 9.50% | 16,020.16 | 34,938.81 | 31,794 | 115,127 |
| 77 | 3 | 9.50% | 16,020.16 | 53,972.86 | 49,655 | 115,127 |
| 78 | 4 | 9.50% | 16,020.16 | 74,132.66 | 68,943 | 115,127 |
| 79 | 5 | 9.50% | 16,020.16 | 95,484.77 | 89,756 | 119,991 |
| 80 | 6 | 9.50% | 16,020.16 | 118,099.72 | 112,195 | 146,220 |
| 81 | 7 | 9.50% | 16,020.16 | 142,052.20 | 136,370 | 173,379 |
| 82 | 8 | 9.50% | 0 | 150,453.68 | 145,940 | 181,134 |
| 83 | 9 | 9.50% | 0 | 159,352.04 | 156,165 | 189,363 |
| 84 | 10 | 9.50% | 0 | 168,776.69 | 167,089 | 198,120 |
| 85 | 11 | 9.50% | 0 | 179,204.02 | 179,204 | 207,966 |
| 86 | 12 | 9.50% | 0 | 190,275.56 | 190,276 | 218,472 |
| 87 | 13 | 9.50% | 0 | 202,031.12 | 202,031 | 229,665 |
| 88 | 14 | 9.50% | 0 | 214,512.96 | 214,513 | 241,572 |
| 89 | 15 | 9.50% | 0 | 227,765.95 | 227,766 | 254,196 |
| 90 | 16 | 9.50% | 0 | 241,837.74 | 241,838 | 267,540 |
| 91 | 17 | 9.50% | 0 | 256,778.91 | 256,779 | 281,594 |
| 92 | 18 | 9.50% | 0 | 272,643.16 | 272,643 | 296,330 |
| 93 | 19 | 9.50% | 0 | 289,487.54 | 289,488 | 311,694 |
| 94 | 20 | 9.50% | 0 | 307,372.60 | 307,373 | 327,595 |
| 95 | 21 | 9.50% | 0 | 326,362.62 | 326,363 | 343,957 |
| 96 | 22 | 9.50% | 0 | 346,525.89 | 346,526 | 360,737 |
| 97 | 23 | 9.50% | 0 | 367,934.87 | 367,935 | 377,976 |
| 98 | 24 | 9.50% | 0 | 390,666.54 | 390,667 | 395,874 |
| 99 | 25 | 9.50% | 0 | 414,802.62 | 414,803 | 414,803 |

### EXAMPLE 5

Female, Aged 55 Nonsmoker

| Attained | | Credited | | Account | Cash | Death |
|---|---|---|---|---|---|---|
| Age | Duration | Rate | Premium | Value | Value | Benefit |
| 55 | 1 | 9.50% | 16,020.16 | 17,026.84 | 15,324 | 250,602 |
| 56 | 2 | 9.50% | 16,020.16 | 35,123.63 | 31,963 | 250,602 |
| 57 | 3 | 9.50% | 16,020.16 | 54,357.59 | 50,009 | 250,602 |
| 58 | 4 | 9.50% | 16,020.16 | 74,800.20 | 69,564 | 250,602 |
| 59 | 5 | 9.50% | 16,020.16 | 96,527.39 | 90,736 | 250,602 |
| 60 | 6 | 9.50% | 16,020.16 | 119,619.89 | 113,639 | 256,027 |
| 61 | 7 | 9.50% | 16,020.16 | 144,163.50 | 138,397 | 299,624 |
| 62 | 8 | 9.50% | 0 | 153,222.56 | 148,626 | 309,286 |
| 63 | 9 | 9.50% | 0 | 162,850.87 | 159,594 | 319,357 |
| 64 | 10 | 9.50% | 0 | 173,084.21 | 171,353 | 329,900 |
| 65 | 11 | 9.50% | 0 | 184,418.70 | 184,419 | 341,818 |
| 66 | 12 | 9.50% | 0 | 196,495.44 | 196,495 | 354,350 |
| 67 | 13 | 9.50% | 0 | 209,363.02 | 209,363 | 367,520 |
| 68 | 14 | 9.50% | 0 | 223,073.24 | 223,073 | 381,333 |
| 69 | 15 | 9.50% | 0 | 237,681.28 | 237,681 | 395,782 |
| 70 | 16 | 9.50% | 0 | 253,245.94 | 253,246 | 410,892 |
| 71 | 17 | 9.50% | 0 | 269,829.85 | 269,830 | 426,714 |
| 72 | 18 | 9.50% | 0 | 287,499.77 | 287,500 | 443,330 |
| 73 | 19 | 9.50% | 0 | 306,326.80 | 306,327 | 460,859 |
| 74 | 20 | 9.50% | 0 | 326,386.74 | 326,387 | 479,433 |
| 75 | 21 | 9.50% | 0 | 347,760.31 | 347,760 | 499,175 |
| 76 | 22 | 9.50% | 0 | 370,533.53 | 370,534 | 520,188 |
| 77 | 23 | 9.50% | 0 | 394,798.07 | 394,798 | 542,551 |
| 78 | 24 | 9.50% | 0 | 420,651.58 | 420,652 | 566,327 |
| 79 | 25 | 9.50% | 0 | 448,198.12 | 448,198 | 591,563 |
| 80 | 26 | 9.50% | 0 | 477,548.55 | 477,549 | 618,335 |
| 81 | 27 | 9.50% | 0 | 508,821.01 | 508,821 | 646,767 |
| 82 | 28 | 9.50% | 0 | 542,141.36 | 542,141 | 677,021 |
| 83 | 29 | 9.50% | 0 | 577,643.71 | 577,644 | 709,289 |
| 84 | 30 | 9.50% | 0 | 615,470.94 | 615,471 | 743,797 |
| 85 | 31 | 9.50% | 0 | 655,775.30 | 655,775 | 780,720 |
| 86 | 32 | 9.50% | 0 | 698,719.01 | 698,719 | 820,240 |
| 87 | 33 | 9.50% | 0 | 744,474.90 | 744,475 | 862,467 |
| 88 | 34 | 9.50% | 0 | 793,227.14 | 793,227 | 907,547 |
| 89 | 35 | 9.50% | 0 | 845,171.94 | 845,172 | 955,551 |
| 90 | 36 | 9.50% | 0 | 900,518.37 | 900,518 | 1,006,572 |
| 91 | 37 | 9.50% | 0 | 959,489.18 | 959,489 | 1,060,610 |
| 92 | 38 | 9.50% | 0 | 1,022,321.71 | 1,022,322 | 1,117,643 |
| 93 | 39 | 9.50% | 0 | 1,089,268.86 | 1,089,269 | 1,177,565 |
| 94 | 40 | 9.50% | 0 | 1,160,600.07 | 1,160,600 | 1,240,182 |
| 95 | 41 | 9.50% | 0 | 1,236,602.44 | 1,236,602 | 1,305,271 |
| 96 | 42 | 9.50% | 0 | 1,317,581.85 | 1,317,582 | 1,372,683 |
| 97 | 43 | 9.50% | 0 | 1,403,864.22 | 1,403,864 | 1,442,639 |
| 98 | 44 | 9.50% | 0 | 1,495,796.84 | 1,495,797 | 1,515,855 |
| 99 | 45 | 9.50% | 0 | 1,593,749.70 | 1,593,750 | 1,593,750 |

The foregoing examples provide typical examples of the growth in account value over a period of years. However, as discussed above, a particular advantage of the invention is its tax efficiency. Example 6 below is a comparative example illustrating comparative investments in a mutual fund, a variable annuity and a simplified variable life insurance policy in accordance with the present invention. The example assumes a single lump-sum deposit of $100,000 is made into each investment. For each product, this single deposit is the invested and all resulting investment income is reinvested during identical accumulation periods. Distributions of accumulated assets are assumed to occur over a 15-year period with the first distribution occurring at varying ages according to issue age. To solve for a level distribution across products, it was assumed that the desired fund at the end of the distribution period is $100,000. This implies that all of the income distributed in the mutual fund and variable annuity is gain. These distributions are therefore fully taxable. In the life insurance product in accordance with the present invention, the favorable tax treatment product means that there is no income tax on funds received via withdrawals or loans from the policy.

In the example, the three investments are all assumed to provide a gross return on investment of 10 percent of the invested amount, and fund management fees are assumed to be 70 basis points per year.

The tax rates used in this analysis are a weighted average of state and federal tax rates in combination with the percentages of mutual fund returns attributable to each of the various income components. The tax rates are assumed to be the 28 percent (28%) federal tax bracket during the accumulation phase, and fifteen percent (15%) federal tax bracket during the payout phase (with a ten percent (10%) federal capital gains tax) and a six percent (6%) state tax rate. (These assumptions for the taxation of the mutual fund are taken from a study conducted by Price Waterhouse Coopers commissioned by the National Association for Variable Annuities.) The tax rates used for the Variable Annuity are 28% Federal and 6% state. An assumption of tax rates is inappropriate to the life product because the technique used to access funds does not result in taxable income.

### EXAMPLE 6

Assumptions:

| Client Name: | John Doe |
|---|---|
| Issue Age: | 45 (0-99) |
| Sex: | M (M or F) |
| Premiums: | |
| Initial Deposit: | $100,000 |
| Gross Investment Rate: | 10.00% |
| Distribution Assumptions | |
| Period of Withdrawals (years) | 15 |
| Beginning in Policy Year: | 21 |
| Desired Fund at End of Income Period: | $100,000 |

Sample Mutual Fund Assumptions:

| | |
|---|---|
| Charges: | 0.70% |
| Asset Management Fee: | |
| Taxation of Distributions | |
| Accumulation Phase Tax Rate: | 19.9% |
| Payout Phase Tax Rate: | 12.4% |
| Resulting Level Distributions | |
| Before Tax: | $11,213 |
| After Tax: | Varies By Year |

Sample Annuity Assumptions:

| | |
|---|---|
| Charges: | |
| Asset Management Fees: | 0.70% |
| Mortality & Expense Charge: | 1.40% |
| Total | 2.10% |
| Taxation of Distributions | 32.3% |
| Federal/State Income Tax Rate: | |
| Resulting Level Distributions | |
| Before Tax: | $45,798 |
| After Tax: | $31,006 |

Simplified Variable Life Insurance Assumptions:

| Charges | Years 1-10 | Years 11+ |
|---|---|---|
| Asset Management Fees: | 0.70% | 0.70% |
| Insurance Asset Charges: | 2.20% | 1.60% |
| Total | 2.90% | 2.30% |

| | |
|---|---|
| Taxation of Distributions | |
| Federal/State Taxes Not Applicable | |
| Resulting Level Distributions | |
| Before Tax: | $37,413 |
| After Tax: | $37,413 |

Summary of Results
After-Tax Distributions by Policy Year:

| | Mutual | | Simplified |
|---|---|---|---|
| Policy Year | Fund | Annuity | Life Insurance |
| 21 | 10,515 | 31,006 | 37,413 |
| 22 | 10,569 | 31,006 | 37,413 |
| 23 | 10,625 | 31,006 | 37,413 |
| 24 | 10,682 | 31,006 | 37,413 |
| 25 | 10,740 | 31,006 | 37,413 |
| 30 | 11,054 | 31,006 | 37,413 |
| 35 | 11,402 | 31,006 | 37,413 |

As can be seen in Example 6, the simplified variable life insurance of the present invention, in the context of the assumptions specified above, provides a substantially better outcome. It should be recognized that different marginal tax rates will impact the efficacy of the outcome. The example also assumes that investments identified as mutual fund investments will have taxable consequences when individuals change the mix of their mutual fund portfolios or take income from the policy. It appears that the higher the applicable tax rate, the more favorable the simplified life insurance of the present invention will be to a consumer.

The present invention provides an easily understood method for the policyholder to understand and predict the future cost of a life insurance policy. In addition, as implemented above, the invention provides the tax advantages of life insurance, including the ability to accumulate dollars on a tax-deferred basis, the access those dollars on a tax-free basis during retirement, and legitimately receive an income tax free death benefit.

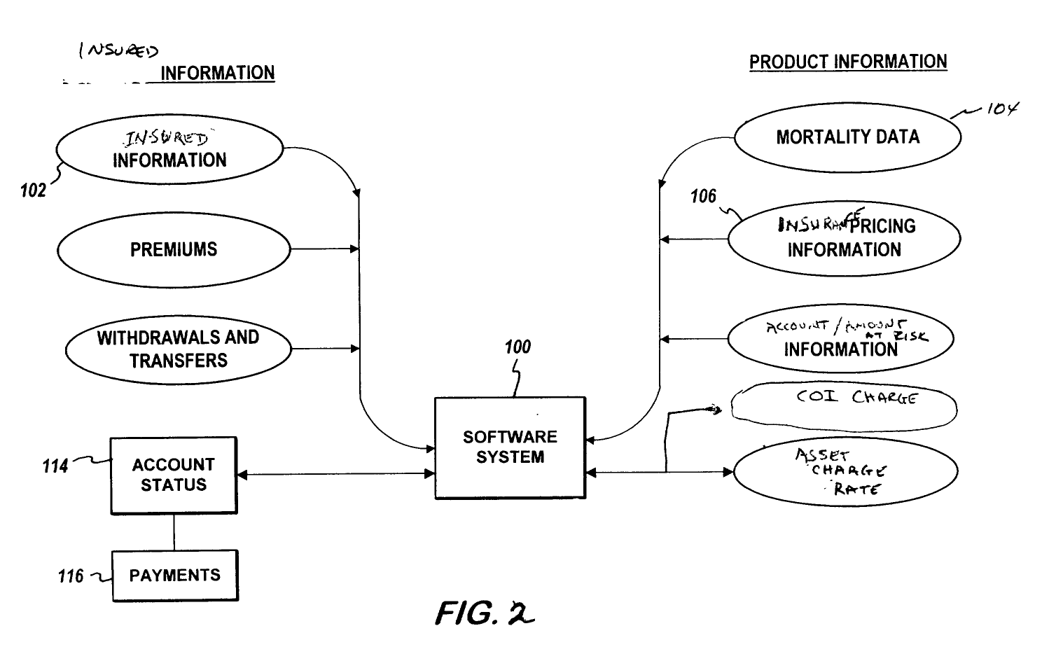

Referring to FIG. 2, software system 100 is preferably implemented as a main program of a software program that comprises various routines or modules to perform the functions of the present invention described herein. Appropriate software structures may be implemented by persons of ordinary skill in the art to implement the present invention. The invention is not limited to the embodiments described herein.

The functions of software system 100 may be implemented in special purpose hardware or in a general or special purpose computer with appropriate operating system and memory storage and input/output devices. In a preferred embodiment the functions of system 100 are controlled by software instructions which direct a computer or other data processing apparatus to receive inputs, perform computations, transmit data internally, transmit outputs and effectuate the receipt and transfer of funds as described herein. The present invention provides a system for managing a simplified variable life insurance product, comprising: (1) data storage for storing product information related to: (a) mortality data and cost of insurance pricing information for determining cost of insurance at different age/sex/underwriting class, (b) account value information for projecting account value during projected future periods, and (2) data processing means for determining premium payment progressions for said simplified variable life insurance product. Data storage may be provided by any suitable storage medium that is accessible by the data processor used to implement the invention. Examples include, random access memory, magnetic tape, magnetic disk, or optical storage media. Software system 100 receives insured information 112 from new life insurance insureds. This information will typically include information about the insured that is pertinent to mortality, (e.g., age, sex, underwriting class), and the type or types of funds selected if the policy is a variable life insurance policy. Insured information 102 is input into a memory accessible by software system 100, using any suitable input device, e.g. by keyboard entry of data into a database. Software system 100 also receives product information such as mortality data 104, used in calculation of life insurance premiums, and other pricing information 106. Software system 100 uses the pricing information 106 and mortality data 104 to determine the necessary premium and premium payment schedules. Software system 100 manages the calculation of an annuity owner's account status 114 and payments 116.

It is to be appreciated that the foregoing is illustrative and not limiting of the invention, and that other modifications of the invention may be chosen by persons of ordinary skill in the art, all within the scope of the invention as claimed below.

What is claimed is:

1. A method of administration of a flexible premium life insurance contract, comprising the steps of:
determining a cost of insurance sufficient to cover life insurance benefits of a flexible premium life insurance contract;
determining a cost of insurance charge sufficient to cover said cost of insurance in said flexible premium life insurance contract;
determining an asset charge as a percentage of an account value of said life insurance contract equal to or greater than said cost of insurance charge.

2. A method of administration of a life insurance contract, in accordance with claim 1, further comprising the step of obtaining payment of said asset charge from a policyholder.

3. A method of administration of a life insurance contract, in accordance with claim 2, further comprising the step of obtaining payment of said asset charge from a policyholder in the form of a periodic premium payment.

4. A method of administration of a life insurance contract, in accordance with claim 2, further comprising the step of obtaining payment of said asset charge from a policyholder in the form of a charge against a cash value of said life insurance contract.

5. A method of administration of a life insurance contract in accordance with claim 1, wherein, in addition to said cost of insurance charge, said asset charge also is equal to or greater than one or more of: the cost of administration of the life insurance product; and the cost of sales of the life insurance product.

6. A method of administration of a life insurance contract in accordance with claim 1, wherein, in addition to said cost of insurance charge, said asset charge also is equal to or greater than the cost of administration of the life insurance product and the cost of sales of the life insurance product.

7. A method of administration of a life insurance contract in accordance with claim 1, wherein a policyholder is charged a premium which consists only of said asset charge.

8. A method of administration of a life insurance contract in accordance with claim 1, wherein said step of determining a cost of insurance charge is calculated separately for each issue age or issue age range.

9. A method of administration of a life insurance product in accordance with claim 1, wherein an amount of said asset charge is selected to be less than or equal to an amount of premium determined by a seven pay insurance contract.

10. A method of administration of a life insurance product in accordance with claim 1, wherein premiums for said life insurance contract are selected to be less than or equal to an amount of premium determined by a seven pay insurance contract.

11. A method of administration a life insurance product in accordance with claim 10, wherein premiums for said life insurance contract are paid from a holding tank investment vehicle over a period of seven or more years.

12. A method of administration of a life insurance product in accordance with claim 11, wherein said holding tank investment vehicle is an immediate annuity.

13. An improvement in a life insurance policy, comprising: a life insurance charge determined as a percentage of an account value of said life insurance contract in an amount sufficient to adequately cover a cost of insurance charge needed to cover life insurance benefits of a life insurance contract.

14. An improvement in a life insurance policy, in accordance with claim 13, wherein said percentage of an account value of said life insurance policy is sufficient to cover the administration costs of the life insurance product and costs of sales of the life insurance product, in addition to said cost of insurance charge.

15. An improvement in a life insurance policy, in accordance with claim 13, wherein said percentage of an account value of said life insurance policy is sufficient to cover one or more of the administration costs of the life insurance product and costs of sales of the life insurance product, in addition to said cost of insurance charge.

16. An improvement in a life insurance policy, in accordance with claim 13, wherein said percentage of an account value is selected to be less than or equal to an amount of premium determined by a seven pay insurance contract.

17. An improvement in a life insurance policy, in accordance with claim 13, wherein premiums for said life insurance policy are selected to be less than or equal to an amount of premium determined by a seven pay insurance contract.

18. An improvement in a life insurance policy, in accordance with claim 17, wherein premiums for said life insurance contract are paid from a holding tank investment vehicle over a period of seven or more years.

19. An improvement in a life insurance policy, in accordance with claim 17, wherein said holding tank investment vehicle comprises an immediate annuity.

20. An improvement in a life insurance policy in accordance with claim 17, wherein said life insurance policy has an initial specified mandatory premium and a subsequent flexible premium.

21. A software system comprising:
data processing apparatus;
means connected to said apparatus for inputting data and instructions to said apparatus;
said software system maintaining a plurality of policyholder accounts, said software system allocating funds received for the benefit of a policyholder to a said policyholder account,
means for calculating an asset charge, said asset charge having a value sufficient to cover a cost of insurance charge for an insured of said policyholder account;
said asset charge being deducted from said policyholder account.
